(19) United States
(12) Patent Application Publication
(10) Pub. No.: US 2010/0294320 A1
(43) Pub. Date: Nov. 25, 2010

(54) Removing undesirable material from grapes

(76) Inventor: Christopher Arthur HENRY, Hastings (NZ)

Correspondence Address: BIO INTELLECTUAL PROPERTY SERVICES (BIO IPS) LLC, 8509 KERNON CT., LORTON, VA, 22079, US

(21) Appl. No.: 12/785,522

(22) Filed: May 24, 2010

(30) Foreign Application Priority Data
May 25, 2009 (NZ) 577176

(51) Int. Cl. B08B 7/00

(52) U.S. Cl. 134/25.1

(57) ABSTRACT

A method of removing undesirable material from grapes comprising the steps of:
a) obtaining an air blower 1 capable of generating and releasing a non-linear substantially disrupted air flow, and
b) directing the non-linear disrupted air flow at bunches of grapes on a vine to remove at least a significant amount of necrotic plant matter from the bunches.

### FIELD OF INVENTION

This invention relates to a method of removing undesirable material from bunches of grapes while hanging on a vine.

### BACKGROUND

A bunch of grapes growing on a vine will often contain a significant amount of necrotic plant matter. Such matter may arise when potential grapes fail to form and as a result die alongside healthy grapes. The necrotic plant matter can lead to diseases such as botrytis infecting healthy grapes and significantly reducing a harvest. It is accordingly an object of a preferred form of the present invention to go some way towards addressing this problem, or to at least provide the public with a useful choice.

### SUMMARY OF INVENTION

According to one aspect of the invention there is provided a method of removing undesirable material from grapes comprising the steps of:
a) obtaining an air blower capable of generating and releasing a non-linear disrupted air flow, and
b) directing the non-linear disrupted air flow at bunches of grapes on a vine to remove at least a significant amount of necrotic plant matter from the bunches.

Preferably the blower comprises an air outlet having a fixed inner flap formed of flexible material which is caught by air flowing through the outlet and caused by such air flow to flap up and down within the outlet to facilitate the substantially disrupted air flow.

Preferably the flap is anchored substantially mid way up the air outlet.

Preferably the flap comprises a strip of synthetic material, for example rubber or webbing, arranged such that the wide surfaces of the strip extend in a transverse direction with respect to the air outlet.

Preferably the air outlet has an air inlet end and an air outlet end wherein the air outlet end is substantially wider than the air inlet end.

Preferably the air outlet is divided into a number of sub air outlets and each sub air outlet has a flap arranged as set out above.

Preferably the disrupted air flow comprises a series of vortexes.

Preferably there is a brief period of relative calm between at least some of the vortexes.

Preferably the blower is transported along a series of grape vines at no more than 5 km/hr with air blowing onto the bunches of grapes as the blower moves alongside them.

### GENERAL DESCRIPTION OF THE DRAWINGS

Some preferred embodiments of the invention will now be described by way of example and with reference to the accompanying drawings, of which:

FIG. 1 is an isometric view showing a blower for use in removing necrotic matter from grapes in a vineyard;

FIG. 2 is an isometric view showing the blower when fitted to a tractor, ready for use;

FIG. 3 is a front view of an outlet duct forming part of the blower; and

FIG. 4 is a side view showing internal parts of the outlet duct;

### DETAILED DESCRIPTION

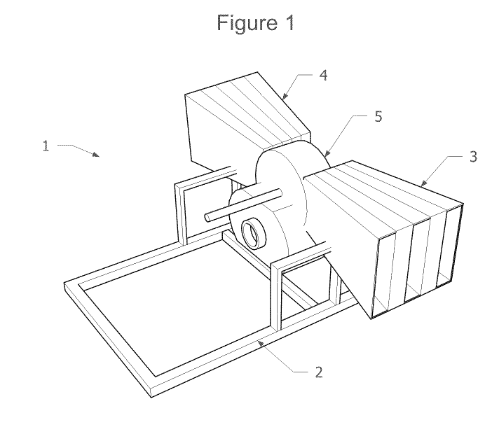

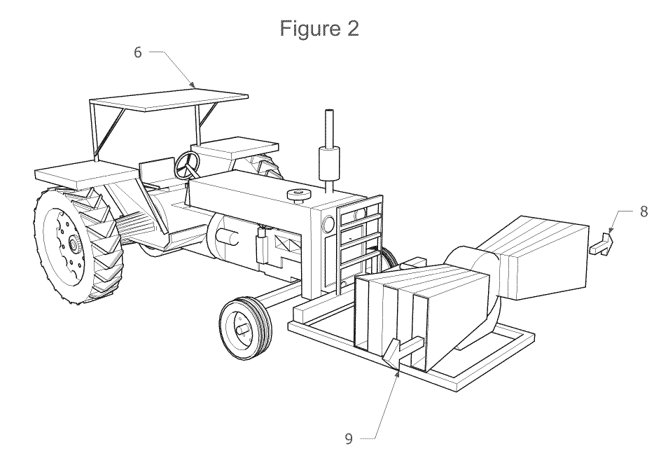

FIG. 1 illustrates a blower 1 having a support frame 2, a pair of air outlet ducts 3, 4 and a fan 5. The blower 1 can be fitted to and be powered by a tractor 6 as shown in FIG. 2. In FIG. 2 the blower 1 is shown fixed to the normal three point linkage system at the front of the tractor but it could of course be fitted at the rear of the tractor, or even to an alternative vehicle if desired. In some embodiments of the invention the blower may be towed on, or as, a trailer or may be moved by hand on a set of wheels.

With the blower 1 fitted as described above the tractor 6 can be driven between rows of grape vines with air blowing out of the two outlet ducts 3, 4 in a sideways manner with respect to the tractor. More specifically the air flow 8, 9 is directed to bunches of grapes (not shown) hanging on the vines to dislodge necrotic plant matter from the bunches. The necrotic plant matter is left to drop to the ground and this reduces the risk of the grapes becoming infected with botrytis or other similar diseases.

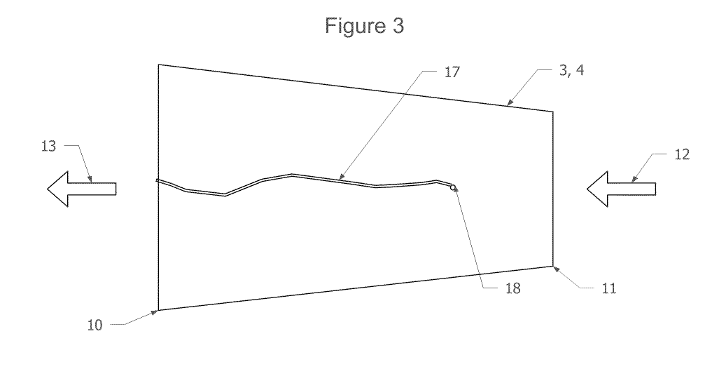

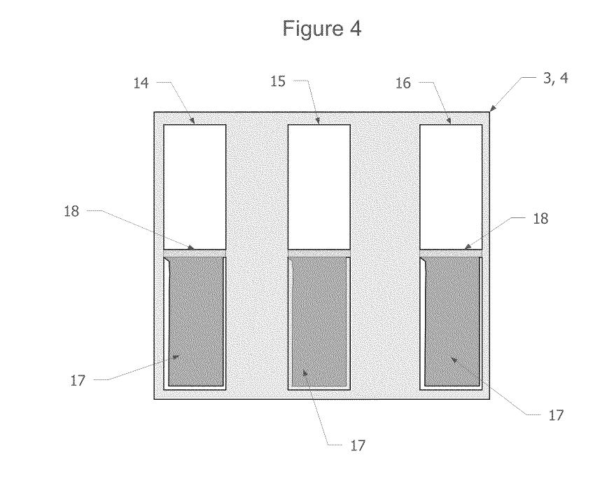

It has been found that directing a substantially linear airflow onto the bunches of grapes can be less than effective in removing the necrotic plant matter. It has however been discovered, surprisingly, that a flow of disrupted air directed onto the bunches can more effectively remove necrotic plant matter. To this end the blower 2 incorporates means for disrupting air flow. Referring to FIGS. 3 and 4, each duct 3, 4 is generally a tapered box shape with a broad outlet end 10 and a narrower air inlet end 11. The general direction of airflow through each duct is indicated by the arrows 12 and 13.

Each duct 3, 4 is divided into three sub ducts 14, 15 and 16 and each sub duct incorporates a flexible flap 17. Each flap 17 is anchored to a horizontal cross bar 18 about mid way up the corresponding sub duct with its broader face aligned across that sub duct. When no air is flowing each flap 17 hangs downwards from the cross bar 18. However when air flows through each sub duct the flap therein is lifted by the moving air and flaps up and down. This results in substantial disruption to the air flow causing such flow to be less than linear when it contacts the grapes. In one embodiment of the invention the flaps 17 cause the air flow to assume a series of vortexes which contact and dislodge necrotic plant matter. In preferred embodiments of the invention there is a brief calm between each wave of turbulent air to facilitate the release of the necrotic plant matter from the grapes.

In one prototype of the invention exceptionally good results were obtained with an air flow of approximately 30 m/sec from three sub ducts each spaced approximately 70 mm apart and having the internal dimensions of 70 mm wide, 490 mm long, 195 mm high at the narrow end and 300 mm high at the wide end. The flaps 17 were each fixed at the vertical mid point of their corresponding sub duct at approximately 360 mm from the outlet end 10. In this case the tractor was driven along rows of grape vines at 1-2 km/hr with the blowers 3, 4 spaced approximately 100-150 mm from the bunches of grapes. It will of course be appreciated that any or all of the above parameters can be altered within reason to arrive at similar result.

While some preferred forms of the invention have been described by way of example it should be appreciated that modifications and improvements can occur without departing from the scope of the appended claims.

1. A method of removing undesirable material from grapes comprising the steps of:
a) obtaining an air blower capable of generating and releasing a non-linear substantially disrupted air flow, and
b) directing the non-linear disrupted air flow at bunches of grapes on a vine to remove at least a significant amount of necrotic plant matter from the bunches.

2. A method according to claim 1, wherein the blower comprises an air outlet having a fixed inner flap formed of flexible material which is caught by air flowing through the outlet and caused by such air flow to flap up and down within the outlet to facilitate the substantially disrupted air flow.

3. A method according to claim 2, wherein the flap is anchored substantially mid way up the air outlet.

4. A method according to claim 2, wherein the flap comprises a strip of synthetic material arranged such that the wide surfaces of the strip extend in a transverse direction with respect to the air outlet.

5. A method according to claim 2, wherein the air outlet has an air inlet end and an air outlet end wherein the air outlet end is substantially wider than the air inlet end.

6. A method according to claim 2, wherein the air outlet is divided into a number of sub air outlets and each sub air outlet has a flap arranged in accordance with claim 2.

7. A method according to claim 1 wherein the disrupted air flow comprises a series of vortexes.

8. A method according to claim 7, wherein there is a brief period of relative calm between at least some of the vortexes.

9. A method according to claim 1, wherein the blower is transported along a series of grape vines at no more than 5 km/hr with air blowing onto the bunches of grapes as the blower moves alongside them.

10. A method according to claim 1 wherein the blower is arranged to direct the non-linear disrupted air flow from each or two opposite sides of the blower.

11. A method of removing undesirable material from grapes comprising the steps of:
a) obtaining an air blower capable of generating and releasing a non-linear substantially disrupted air flow, the air blower comprising an air outlet, the air outlet having an air inlet end and an air outlet end, the air outlet end being broader than the air inlet end, the air outlet having a plurality of fixed inner strips of flexible material arranged with wide surfaces of each strip extending transverse with respect to the air outlet and such that each strip is caught by air flowing through the air outlet and flaps up and down within the air outlet to facilitate the substantially disrupted air flow; and
b) directing the non-linear disrupted air flow at bunches of grapes on a vine to remove at least a significant amount of necrotic plant matter from the bunches.

12. A method according to claim 11, wherein the blower directs the non-linear disrupted air flow from each of two opposite sides of the blower.
